(19) United States
(12) Patent Application Publication
(10) Pub. No.: US 2004/0088361 A1
(43) Pub. Date: May 6, 2004

(54) Method and system for distributing information to services via a node hierarchy

(76) Inventor: Stuart Statman, Seattle, WA (US)

Correspondence Address: PERKINS COIE LLP, PATENT-SEA, P.O. BOX 1247, SEATTLE, WA, 98111-1247, US

(21) Appl. No.: 10/289,473

(22) Filed: Nov. 6, 2002

(51) Int. Cl. G06F 15/16

(52) U.S. Cl. 709/206

(57) ABSTRACT

A computer-based method and system for distributing information from a source to a service that is to process the information. The distribution system provides a node hierarchy of distribution nodes and service nodes. The node hierarchy has a root node, which is a distribution node, that receives information that is to be distributed to a service node. The root node passes the received information to its child nodes, which may be either distribution nodes or service nodes. Each child node may determine whether or not to accept the information for further distribution or for servicing. If a distribution node accepts the passed information, then it passes the information to each of its child nodes. The information is thus passed down the node hierarchy through distribution nodes to service nodes that will accept and process the information.

### TECHNICAL FIELD

The described technology relates generally to distributing information and particularly to distributing information to an appropriate service to process the information.

### BACKGROUND

Software systems are capable of processing vast amounts of information.

Software systems are often monolithic systems that receive information (e.g., requests, responses, messages, and signals) from information sources, parse the received information, and then invoke an appropriate module to process the received information. The modules that process the information may provide a response that is to be sent back to the information source. The use of such monolithic software systems has several disadvantages. First, it can be very difficult and expensive to modify such software systems to add new capabilities by developing a new module or by modifying an existing module. In addition, the parsing process may need to be modified to allow the new capabilities to be accessed. In a monolithic software system, such modifications may introduce errors and reveal existing errors that need to be fixed. Second, such systems are typically not scalable in the sense that it may be difficult to add capacity to process increasing amounts of information. For example, it may be difficult to distribute the processing of a monolithic software system across multiple computer systems.

Some software systems have been developed that can address some of the disadvantages of such monolithic software systems. Some software systems implement a multi-tiered architecture that includes a firewall tier, a load balancing tier, a web server tier, an application tier, and a database tier. By separating the various functions of such software systems into tiers, the overall complexity may be reduced, which can reduce the difficulty and costs of adding new capabilities. Such multi-tiered architectures are typically more scalable in that additional computer resources can be added at each tier to accommodate the processing of increasing amounts of information. For example, the web server tier may parse requests and forward the requests to the appropriate computer system at the application tier. Initially, the application tier may have one computer system to process certain types of requests. The web servers would forward all such requests to that one computer system. As demand increases, an additional computer system to process the same type of requests may be added to the application tier. The web servers would then forward those type of requests to either of the computer systems of the application tier. In this way, capacity can be added incrementally to support increases in demand.

It would be desirable to have a software architecture that would allow more efficient and less complex distribution of information to the appropriate computer systems or modules for servicing the information.

### BRIEF DESCRIPTION OF THE DRAWINGS

FIG. 1 is a block diagram illustrating a node hierarchy in one embodiment.

FIG. 2 is a block diagram illustrating components of a distribution object in one embodiment.

FIG. 3 is a block diagram illustrating multiple node hierarchies in one embodiment.

FIG. 4 is a block diagram illustrating nodes of the same node type in different node hierarchies in one embodiment.

FIG. 5 is a flow diagram illustrating processing of the constructor for the queued consumer class in one embodiment.

FIG. 6 is a flow diagram illustrating processing of the pass function of the queued consumer class in one embodiment.

FIG. 7 is a flow diagram illustrating processing of the start function of the queued consumer class in one embodiment.

FIG. 8 is a flow diagram illustrating processing of the stop function of the queued consumer class in one embodiment.

FIG. 9 is a flow diagram illustrating processing of the pause function of the queued consumer class in one embodiment.

FIG. 10 is a flow diagram illustrating processing of the constructor of the traffic manager class in one embodiment.

FIG. 11 is a flow diagram illustrating processing of the add queued consumer function of the traffic manager class in one embodiment.

FIG. 12 is a flow diagram illustrating processing of the remove queued consumer function of the traffic manager class in one embodiment.

FIG. 13 is a flow diagram illustrating processing of the act function of the traffic manager class in one embodiment.

FIG. 14 is a flow diagram illustrating processing of the constructor of the queue class in one embodiment.

FIG. 15 is a flow diagram illustrating processing of the start function of the queue class in one embodiment.

FIG. 16 is a flow diagram illustrating processing of the stop function of the queue class in one embodiment.

FIG. 17 is a flow diagram illustrating processing of the pause function of the queue class in one embodiment.

FIG. 18 is a flow diagram illustrating processing of the add queue listener function of the queue class in one embodiment.

FIG. 19 is a flow diagram illustrating processing of the remove queue listener function of the queue class in one embodiment.

FIG. 20 is a flow diagram illustrating processing of the push function of the queue class in one embodiment.

FIG. 21 is a flow diagram illustrating processing of the pop function of the queue class in one embodiment.

FIG. 22 is a flow diagram illustrating processing of the pop function of the inner queue class in one embodiment.

FIG. 23 is a flow diagram illustrating processing of the push function of the inner queue class in one embodiment.

FIG. 24 is a flow diagram illustrating processing of the halt function of the queue popper class in one embodiment.

FIG. 25 is a flow diagram illustrating processing of the run function of the queue popper class in one embodiment.

FIG. 26 illustrates the processing of an initialize function, functions of the distribution gate, and functions of a switch.

FIG. 27 is a flow diagram illustrating the instantiation of a leaf node and its parent node in one embodiment.

### DETAILED DESCRIPTION

A computer-based method and system for distributing information from a source to a service that is to process the information is provided. In one embodiment, the distribution system provides a node hierarchy (also referred to as a distribution hierarchy) of distribution nodes and service nodes. The node hierarchy has a root node, which is a distribution node, that receives information that is to be distributed to a service node. The root node passes the received information to its child nodes, which may be either distribution nodes or service nodes. Each child node may determine whether or not to accept the information for further distribution or for servicing. If a distribution node accepts the passed information, then it passes the information to each of its child nodes. The information is thus passed down the node hierarchy through distribution nodes to service nodes that will accept and process the information. Thus, the distribution nodes are non-leaf nodes of the node hierarchy, and the service nodes are leaf nodes of the node hierarchy. The distribution system allows various distribution and service nodes to be implemented on the same or different computer systems.

In one embodiment, each distribution and service node is implemented as a consumer queue object. A consumer queue object may include a queue component with a queue for storing information that is received but not yet processed by the node. The consumer queue object may also include a pass component and an act component. The pass component receives information that is to be distributed, determines whether the information is to be accepted by the node, and pushes the accepted information onto the queue. The act component processes the queued information. The queue component may also include a thread component that executes as a node-specific thread that waits for information to be placed in the queue, pops the information off the queue, and invokes the act component to process the information. The act component of a distribution node may execute within the thread for that node and passes the information to each child node by invoking the pass component of the child node. The consumer queue object may also include an accept component that is invoked by the pass component to determine whether the information is to be accepted by the node. (The term “thread” refers to a separately executable entity of a process. A process can have one thread or multiple threads. Thus, the thread components of the node hierarchy can execute as threads within the same process, or each thread component can execute as a single thread within different processes.)

Each node may use a common implementation of the queue component and pass component, but may use an accept component and an act component that are customized to the particular distribution or service provided by that node. The accept component of a distribution node may be implemented to accept only information that can be accepted by at least one of its child nodes, and the act component of a distribution node may be implemented to pass the information to the pass component of each of its child nodes. The accept component of a service node may be implemented to accept only the information that can be processed by that service node, and the act component of a service node may be implemented to effect performance of the service associated with that service node. Because of the common implementation of the queue component, each node of the node hierarchy has its own thread associated with it for processing the information placed on the queue. When information is passed to a root node and then placed in its queue, the thread of the root node pops the information off the queue and invokes the pass component of each child node, which pushes the accepted information onto the queue for that child node. The thread associated with each child node that accepts the information pops the information from its queue for further distribution to child nodes in the case of a distribution node and for servicing in the case of a service node.

In one embodiment, the nodes of a node hierarchy are instantiated in a bottom-up manner. Initially, all service nodes, which are the leaf nodes, are instantiated. Each node knows the node type of its parent node. When a node is instantiated, it connects to its parent node. It connects by first retrieving a reference to a node of its parent node type. If a node of the parent node type has not been instantiated, then a node of the parent node type is instantiated. A reference to that parent node is returned to the child node. To complete the connection, the child node then registers itself with its parent node so that the child node can be passed information from the parent node. When the parent node is instantiated, it connects to its parent node. It connects by retrieving a reference to a node of its parent node type. If a node of its parent node type has not been instantiated, then a node of its parent node type is instantiated. A reference to that parent node is then returned to the parent node. The parent node then registers with its parent node to complete the connection. This process continues until a root node is instantiated that has no parent node type. The bottom-up instantiation of the node hierarchy results in the instantiation of only those distribution nodes that are needed to distribute information to the set of service nodes that are being instantiated.

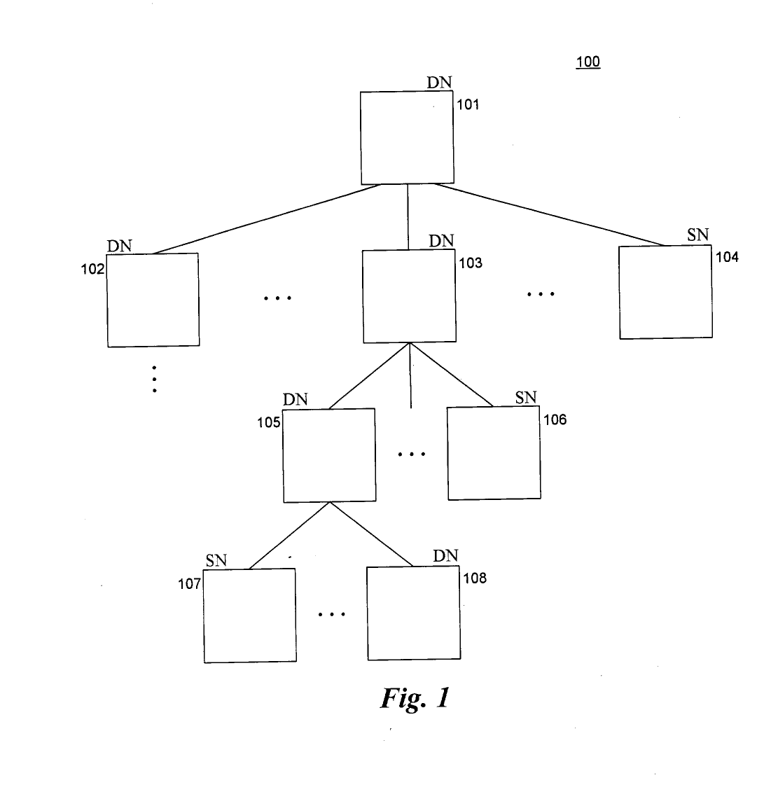

FIG. 1 is a block diagram illustrating a node hierarchy in one embodiment. The node hierarchy 100 includes nodes 101-108. Nodes 101, 102, 103, 105, and 108 are distribution nodes, and nodes 104, 106, and 107 are service nodes. Distribution node 101 is a root node. In this embodiment, the node hierarchy is a tree structure in that each node has only one parent node, except for the root node, which has no parent node. One skilled in the art will appreciate that a node hierarchy may not be a tree structure. For example, a node may have multiple parent nodes, and a node hierarchy may have more than one root node. The horizontal ellipses of FIG. 1 indicate sibling nodes that are not illustrated, and the vertical ellipses of FIG. 1 indicate child nodes that are not illustrated. When information is to be distributed down through the node hierarchy, the information is first passed to the root node 101. The root node may determine whether the information is acceptable, and if acceptable, it passes the information to each of its child nodes 102-104. Child nodes 102 and 103 determine whether the passed information is acceptable and if acceptable, pass the information along to their child nodes, such as child nodes 105-106. Child node 104 is a service node that may determine whether the information is acceptable and if acceptable, effects performance of the service associated with that service node. The service node may directly perform the service or direct another computing entity (e.g., process, object, module) to perform the service. Thus, the information propagates down the node hierarchy through the distribution nodes that find the information acceptable until it is received and processed by those service nodes that find the information acceptable.

The node hierarchy 100 may be created in a bottom-up manner. In particular, each service node 104, 106, and 107 may be instantiated initially. If service node 104 is instantiated first, it requests that the root node 101 be instantiated and receives a reference to the root node 101. In one embodiment, each node type has an associated singleton with a function that is responsible for instantiating an object for that node type if one is not already instantiated and returning a reference to that object. Alternatively, the function may be implemented as a static function of the node type class, rather than as a singleton. The service node 104, using the received reference, registers to receive information from the root node 101. Each node has access to its parent node type, which in the case of a root node is null. If service node 106 is instantiated second, it requests that distribution node 103 be instantiated, receives a reference to distribution node 103, and, using the reference, registers to receive information from distribution node 103. When distribution node 103 is instantiated, it requests that its parent node, the root node 101, be instantiated. Since the root node 101 is already instantiated, distribution node 103 is provided with a reference to the root node 101 so that it can register with the root node 101. If service node 107 is instantiated third, it requests that distribution node 105 be instantiated, receives a reference to distribution node 105, and, using the received reference, registers to receive information from distribution node 105. Distribution node 105 then requests that distribution node 103 be instantiated. Since distribution node 103 is already instantiated, distribution node 105 is provided with a reference to distribution node 103 and uses the reference to register with distribution node 103. This process continues until all the service nodes have been instantiated and registered with their parent distribution nodes. In addition, service nodes can dynamically be instantiated as a service comes on line. In such a case, the parent distribution nodes are also dynamically instantiated as appropriate. When a service goes off line, the corresponding service node notifies its parent node. The parent node determines whether it has any more child nodes. If not, it notifies its parent node (so that its parent node can determine whether it has any more child nodes) and then destructs itself. After the parent node has been notified and has destructed itself, the service node destructs itself.

The distribution system may execute on computers that include a central processing unit, memory, input devices (e.g., keyboard and pointing devices), output devices (e.g., display devices), and storage devices (e.g., disk drives). In certain embodiments, the distribution system may execute on special purposes computers, such as network switches. The memory and storage devices are computer-readable media that may contain instructions that implement the distribution system. In addition, the data structures and message structures may be stored or transmitted via a data transmission medium, such as a signal on a communications link.

In the described example, the nodes of the node hierarchy execute within a single process within a single computer system. The nodes of the node hierarchy, however, may execute on the same processor of the same computer, on different processors of the same computer, or on different computers. In addition, the nodes can execute within the same process or different processes. The allocation of nodes between different processors or computers and between different processes can be made to affect overall performance and capacity of the distribution system. The nodes can communicate with one another using local (i.e., in-process) procedure calls, remote procedures call, inter-process communication channels, pipes, sockets, message passing, and so on. The nodes may be implemented using various programming languages, such as Java, C++, and assembly language.

In one embodiment, the distribution system supports message distribution within the Infiniband Management Model. InfiniBand is a switched-fabric architecture for I/O system and data centers. InfiniBand has been developed by the InfiniBand Trade Association (www.infinibandta.org) and is described in The InfiniBand Architecture, 1.0.a Specifications released Jun. 15, 2001, which is hereby incorporated by reference. InfiniBand defines network interfaces to I/O nodes and processor nodes that are interconnected via switches. The network may be divided into subnetworks (i.e., subnets) that are interconnected via routers. The InfiniBand Management Model describes the functions of a management layer that include topology discovery, configuration, communications, and fault tolerance. The InfiniBand Management Model specifies Subnet Managers (“SMs”), Subnet Management Agents (“SMAs”), General Service Managers (“GSMs”), and General Service Agents (“GSA”). Every InfiniBand node has an SMA and may have multiple GSA. The distribution system may be used to distribute information to the managers and agents of the InfiniBand network. The service nodes of a node hierarchy can provide the processing of the managers and agents. Referring to FIG. 1, distribution node 102 may be implemented to accept only general service messages, and distribution node 103 may be implemented to accept only subnet messages. Service node 106 may be implemented to accept SM messages and to perform the subnet manager functions. Distribution node 105 may be implemented to accept SMA messages and distribute those messages to the appropriate SMAs, such as service node 107.

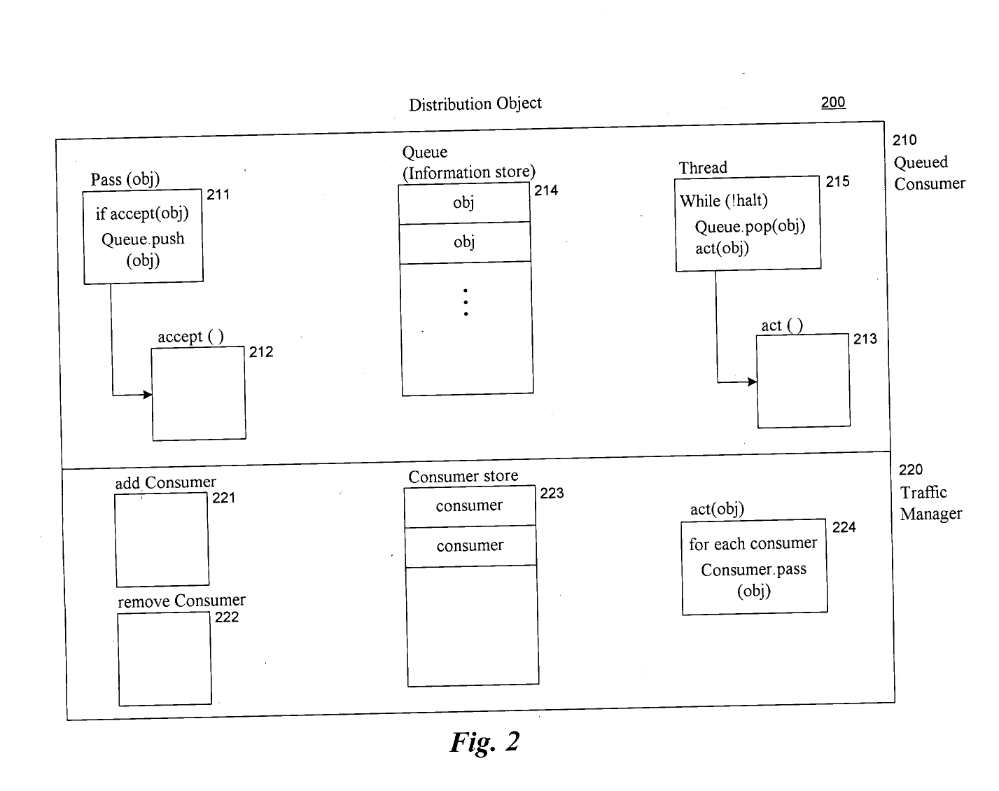

FIG. 2 is a block diagram illustrating components of a distribution object in one embodiment. A distribution object is a type of a consumer queue object that may be used to implement a distribution node. The distribution object 200 includes a queued consumer component 210 and a traffic manager component 220. Each consumer queue object (e.g., representing a distribution node or a service node) includes a queued consumer component, and each distribution object includes a traffic manager component.

The queued consumer component includes a pass component 211, an accept component 212, an act component 213, a queue 214, and a thread 215. The queue and the thread are part of a queue component. A reference to the pass component is provided to the parent node at registration so that-the parent node can pass information (e.g., represented as an object “obj”) to the pass component. When the pass component is invoked, it invokes the accept component passing the information to determine whether the information should be processed by this node. The accept component is customized to the particular node type. If the information is acceptable, then the pass component pushes the information onto the queue. The thread component pops information off the queue and invokes the act component to process the information. The act component is customized to the particular node type. The queued consumer component may be defined as an abstract class that is inherited by the class of each object representing a node in the node hierarchy. One skilled in the art will appreciate that the queue can be replaced with various types of data stores or data structures for storing information that are not necessarily queue-like data structures. For example, the information store of a distribution object may be a table of information with associated priorities. In such a case, the thread may pull the information from the table in priority order. Such an information store is not queue-like in that it is not first-in-first-out. Also, one skilled in the art will appreciate that the thread may be actually implemented in a separate process, rather than a separate thread of the same process. Also, in some nodes the component that pulls information out of the information store may not execute in a separate thread or process or may execute in a thread or process shared by multiple nodes.

The traffic manager component 220 includes an add consumer component 221, a remove consumer component 222, a consumer store 223, and an implementation of the act component 224. The add consumer component and remove consumer component are invoked by child nodes to register and unregister to receive (or consume) information from a parent node. A child node is referred to as a consumer. These components add and remove references to the child nodes to and from the consumer store. The traffic manager component also provides an implementation of the act component that receives the information from the thread and passes the information to each consumer in the consumer store by invoking the pass component of that consumer. The class of a distribution object may inherit a traffic manager class that inherits a queued consumer class. The traffic manager class is abstract because it provides no implementation of the accept component. The accept component can then be customized to the particular distribution node.

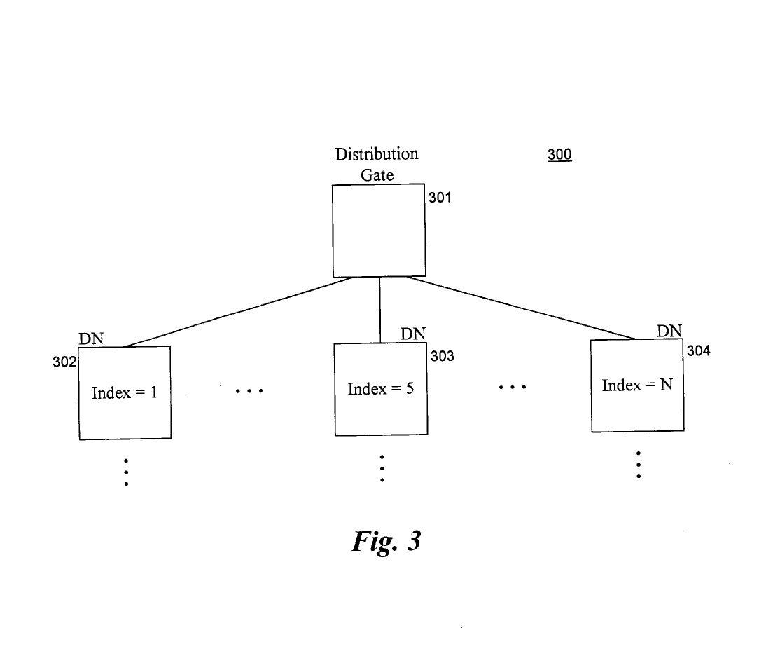

FIG. 3 is a block diagram illustrating multiple node hierarchies in one embodiment. The node hierarchies 300 are tied together by a distribution gate 301. Distribution nodes 302, 303, and 304 are root nodes of node hierarchies. The vertical ellipses indicate that the nodes of the node hierarchy under the root node are not shown, and the horizontal ellipses indicate that additional node hierarchies are not shown. Each node hierarchy may have an associated index. For example, the node hierarchy whose root is distribution node 302 has an index of 1, and the node hierarchy whose root node is distribution node 303 has an index of 5. As discussed below in more detail, when each service node is instantiated, it is provided with the index of the node hierarchy of which it is to be part. Thus, multiple instances of a service node of a certain node type may be instantiated as part of different node hierarchies. (In one embodiment, a single node hierarchy may have multiple instances of the same type of distribution or service node, for example, to increase capacity or could be limited to one as in the described embodiment.) The distribution gate is responsible for receiving information and passing the information to the root node of the appropriate node hierarchy. If the node hierarchy is currently not created, then the distribution gate controls the instantiation of the node hierarchy by instantiating the service nodes for that node hierarchy. As described below, each node hierarchy has a switch component that controls the instantiation of the node hierarchy. The distribution component invokes the appropriate switch component to create a node hierarchy.

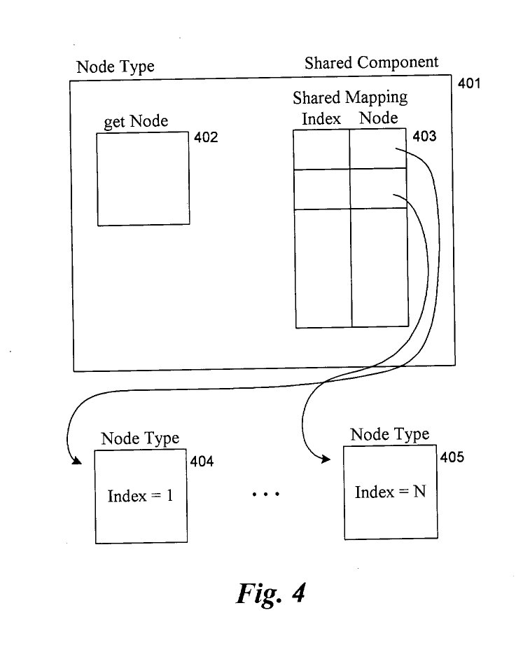

FIG. 4 is a block diagram illustrating nodes of the same node type in different node hierarchies in one embodiment. In this embodiment, each node hierarchy is allowed only one node of each node type. Each node type has a shared component 401 with a get node component 402 and shared mapping 403. The shared mapping maps indexes to references to nodes of that node type, such as nodes 404 and 405. The shared mapping has a mapping for each instance of a node of that type in a node hierarchy. The get node component is invoked by each child node during instantiation of the child node and is passed an index of the node hierarchy of the child node. The get node component checks the mapping to determine whether a node of the node type with that index has already been instantiated. If not, the get node component instantiates a node of that node type for that index and adds to the shared mapping an entry that maps the index to the instantiated node. The get node component then returns a reference to the parent node to the child node. The child node can then use that reference to register with the parent node.

Tables 1-5 illustrate various class definitions in one embodiment. The ellipses indicate that implementations of the function are provided by the classification.

TABLE 1
Queued Consumer Class

public abstract class AbstractQueuedConsumer {

private Queue coQueue;
private int ciStatus;
private int ciSwitchIndex;
private Switch coSwitch;
public abstract boolean accept(Object object);
public abstract void act(Object object);
public AbstractQueuedConsumer(int switchIndex, int queueSize) {.}
public final Switch getSwitch( ) {.}
public final void pass(Object object) { }
public final void start( ) {...}
public final void stop( ) {...}
public final void pause( ) {...}
public void started( ) { }
public void stopped( ) { }
public void paused( ) { }

}

TABLE 2
Traffic Manager Class

public abstract class AbstractTrafficManager extends

AbstractQueuedConsumer {

private List coQueuedConsumers;
public abstract boolean accept(Object object);
public AbstractTrafficManager(int switchIndex, int queueSize) {...}
public synchronized final void

addQueuedConsumer(AbstractQueuedConsumer
abstractQueuedConsumer) {...}

public synchronized final void

removeQueuedConsumer(AbstractQueuedConsumer
abstractQueuedConsumer) {..}

private synchronized void act (Object object) { }

}

TABLE 3
Distribution Gate Class

```
public class ACGate {
  private static ACGate csACGate;
  public final static ACGate getACGate( ) {...}
  private ACGate( ) { }
  public void powerOn(int switchIndex) {...}
  public void sendPacketIn(int switchIndex, InfiniBandPacket packet) {.}
  public void sendPacketOut(int switchIndex, int portIndex,
```

InfiniBandPacket packet) {..}

}

TABLE 4
Switch Class

public class Switch extends AbstractTrafficManager {

private static HashMap coSwitchList = new HashMap(1);
public final static Switch getSwitch(int switchIndex) { }
private boolean cbSMOn;
private int ciSwitchIndex;
private Switch(int switchIndex) {..}
public void powerOn( ) {..}

}

TABLE 5
Queue Class

public class Queue {

private List coListeners = new LinkedList( );
private QueuePopper coQueuePopper;
private InnerQueue coQueue;
public Queue(int queueSize) { }
public synchronized final void start( ) {...}
public synchronized final void stop( ) {...}
public synchronized final void pause( ) {.}
public final synchronized void addQueueListener(IQueueListener

queueListener) {..}

public final synchronized void removeQueueListener(IQueueListener

queueListener) {..}

public final void push(Object object) { }
private synchronized void pop(Object object) {...}
private class InnerQueue {

private Object[] coQueueElements;
private int ciQueueHead;
private int ciQueueNext;
private int ciQueueSize;
private int ciQueueStatus;
private int ciQueueElementCount;
public InnerQueue(int queueSize) {...}
public synchronized Object pop( ) {...}
public synchronized void push(Object object) { }

}
private class QueuePopper extends Thread {

private boolean cbHalt = false;
public void halt( ) { }
public void run( ) { }

}

}

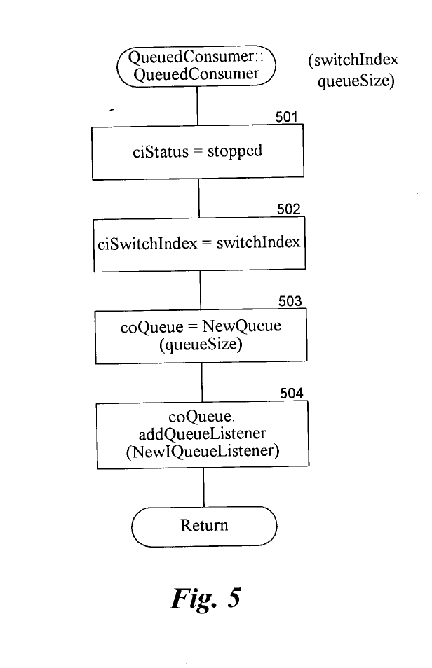

FIGS. 5-27 are flow diagrams illustrating several implementations of functions of the various classes into one embodiment. FIGS. 5-9 are flow diagrams of the components of the queued consumer class in one embodiment. FIG. 5 is a flow diagram illustrating processing of the constructor for the queued consumer class in one embodiment. The constructor is passed an index and a queue size (i.e., information store size). The index indicates the node hierarchy of which the node is to be part. In decision block 501, the constructor sets the status of the node to stopped. A node may have a status of a stopped, started, or paused. In block 502, the constructor sets a data member to the passed index. In block 503, the constructor creates a queue component with a queue of the passed queue size. In block 504, the constructor registers the node as a listener of the queue. In one embodiment, the queue component of the node may allow for multiple listeners to be registered. When the queue component pops information off the queue, it invokes the act component of each registered listener. One skilled in the art will appreciate that, in one embodiment, each queue of a node can be limited to only one listener. Multiple queue listeners may be helpful when logging information or when debugging. The component then returns.

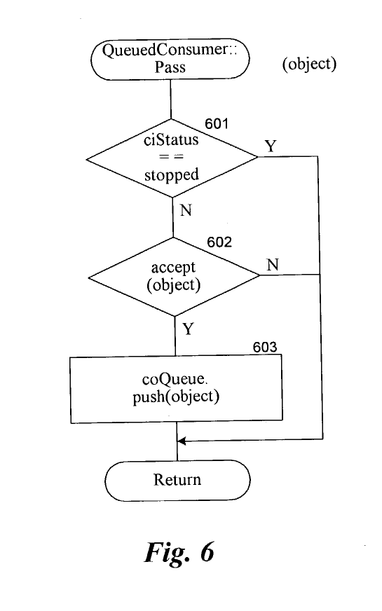

FIG. 6 is a flow diagram illustrating processing of the pass function of the queued consumer class in one embodiment. The pass function is passed the information (e.g., an object containing the information) to be provided to the node. In decision block 601, if the status of the node is stopped, then the node is in a state in which it cannot receive information and the function returns, else the function continues at block 602. In decision block 602, the function invokes the accept function passing the passed information. If the accept function indicates that the information is acceptable, then the function continues at block 603, else the function returns. In block 603, the component pushes the information onto the queue and then returns.

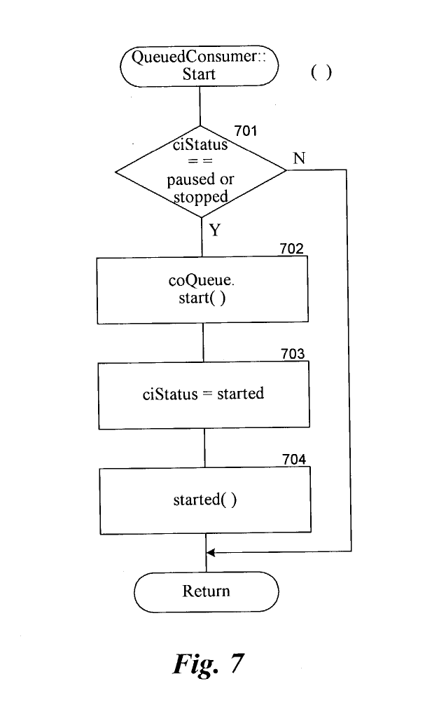

FIG. 7 is a flow diagram illustrating processing of the start function of the queued consumer class in one embodiment. The start function is invoked when the node is to be started when the node is instantiated. The switch component may invoke the start function of a leaf node, and the registering function (e.g., add consumer function) may invoke the start function of a non-leaf when the first consumer is registered. In decision block 701, if the status of the node is paused or stopped, then the function continues at block 702, else the function returns because the node is already started. In block 702, the function starts the queue component. In block 703, the function sets the status of the node to started. In block 704, the function invokes the started function and then returns. The started function has an implementation in the queued consumer class that simply returns. A class that inherits the queued consumer class can override the started function to perform customize processing when a node is started. For example, the started function may perform the processing of instantiating and linking to its parent node.

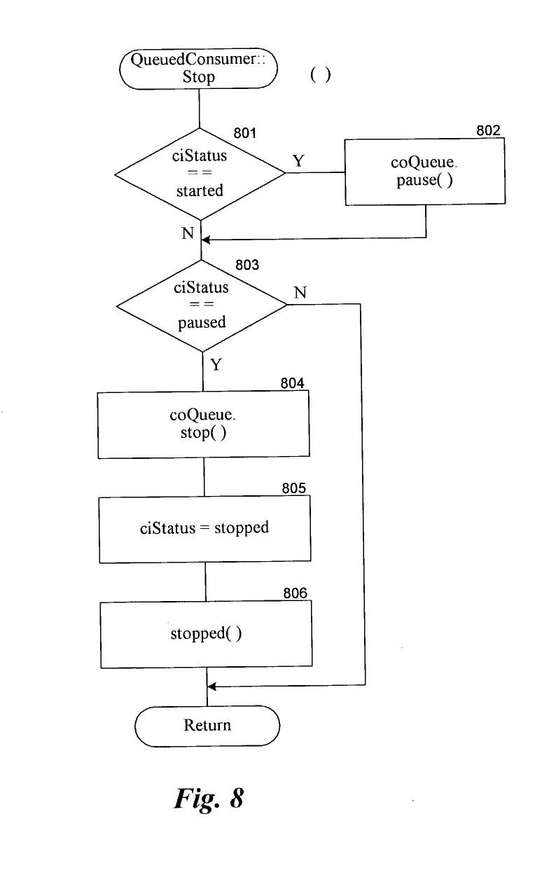

FIG. 8 is a flow diagram illustrating processing of the stop function of the queued consumer class in one embodiment. The stop function is invoked when a node is to stop processing information. In decision block 801, if the current status of the node is started, then the function continues at block 802, else the function continues at block 803. In block 802, the function pauses the queue, which prevents information from being popped off the queue, and continues at block 803. In decision block 803, if the current status of the node is paused, then the function continues at block 804, else the function returns because the node is already stopped. In block 804, the function stops the queue, which prevents information from being pushed onto or popped off the queue. In block 805, the function sets the current status of the node to stopped. In block 806, the function invokes the stopped function and then returns. The stopped function has an implementation in the queued consumer class that simply returns. A class that inherits the queued consumer class can override the stopped function to perform customize processing when a node is stopped, such as unregistering from its parent node and destructing the node.

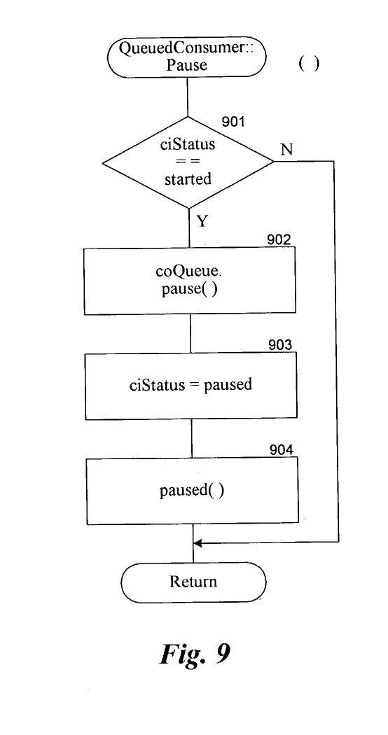

FIG. 9 is a flow diagram illustrating processing of the pause function of the queued consumer class in one embodiment. The pause function is invoked when a node is to have its processing paused. In decision block 901, if the current status of the node is started, then the function continues at block 902, else the function returns because the node is either already paused or stopped. In block 902, the function pauses the queue. In block 903, the function sets the current status of the node to paused. In block 904, the function invokes the paused function and then returns. The paused function has an implementation in the queued consumer class that simply returns. A class that inherits the queued consumer class can override the paused function to perform customize processing when a node is paused.

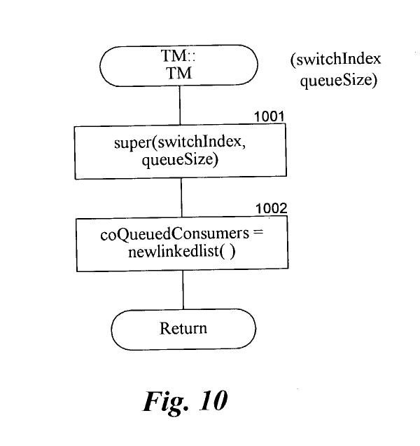

FIGS. 10-13 are flow diagrams illustrating processing of functions implemented by the traffic manager class in one embodiment. The traffic manager class inherits the queued consumer class and implements a constructor, an add queued consumer function, a remove queued consumer function, and an act function. FIG. 10 is a flow diagram illustrating processing of the constructor of the traffic manager class in one embodiment. The constructor is invoked by the constructor for a distribution node. The constructor is passed an index and a queue size, which is the size of the consumer store. In block 1001, the constructor passes the index and the queue size to the constructor of the inherited queued consumer class. In block 1002, the component creates a consumer store and then returns.

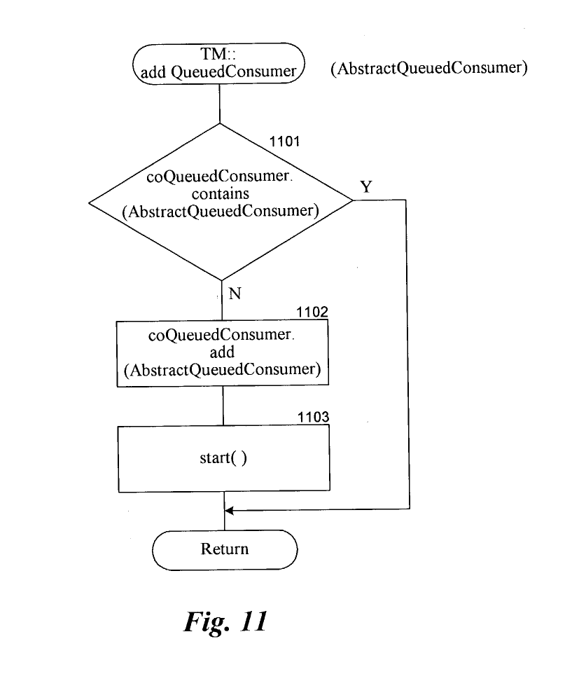

FIG. 11 is a flow diagram illustrating processing of the add queued consumer function of the traffic manager class in one embodiment. This function is an implementation of the add consumer component. This function is passed a reference to a consumer and adds that consumer to the consumer store. In decision block 1101, if the consumer store already contains that consumer, then the function returns, else the function continues at block 1102. In block 1102, the function adds the consumer to the consumer store. In block 1103, the function invokes the start function of this node and then returns. The start function gives an opportunity for this node to instantiate and link to its parent node when the first consumer is added to the consumer store (i.e., child node registers).

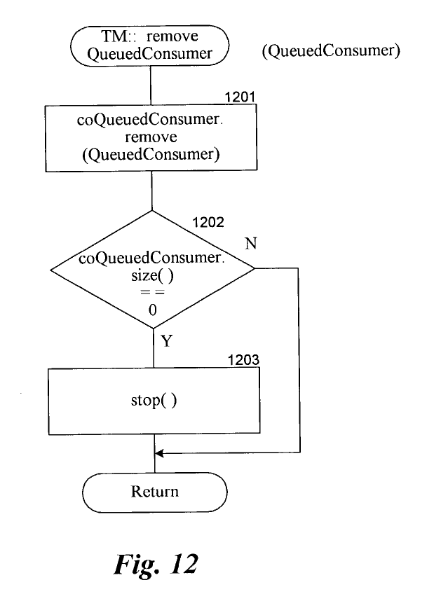

FIG. 12 is a flow diagram illustrating processing of the remove queued consumer function of the traffic manager class in one embodiment. This function is an implementation of the remove consumer component. This function is passed an indication of the consumer (i.e., child node) to remove. In block 1201, the function removes the consumer from the consumer store. In decision block 1202, if all the consumers have been removed from the consumer store, then the function continues at block 1203, else the function returns. In block 1203, the function invokes the stop function. The stop function gives this node the opportunity to remove itself from the node hierarchy when this node has no consumers.

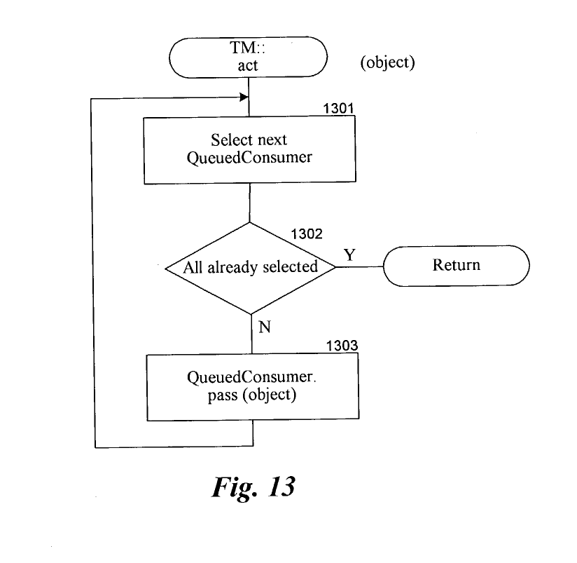

FIG. 13 Is a flow diagram illustrating processing of the act function of the traffic manager class in one embodiment. The function is passed information that is to be acted upon. In blocks 1301-1303, the function loops passing the information to each consumer. In block 1301, the function selects the next consumer in the consumer store. In decision block 1302, if all the consumers have already been selected, then the function returns, else the function continues at block 1303. In block 1303, the function invokes the pass function of the selected consumer passing the information and then loops to block 1301 to select the next consumer.

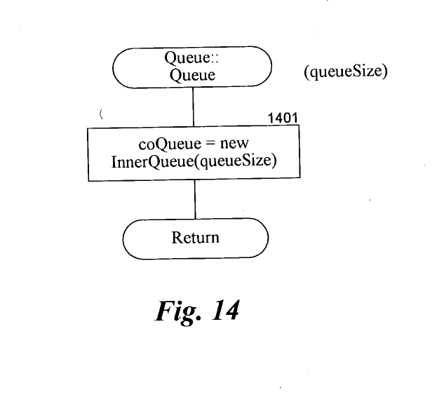

FIGS. 14-25 are flow diagrams illustrating processing of the functions of the queue class and related classes in one embodiment. The queue class includes an inner queue class and a queue popper class. The inner queue class provides the actual queue and functions to pop information off the queue (and wait if empty) and to push information onto the queue and signal that the queue contains information. The queue popper class provides the main function of the thread that loops popping information off the queue and passing the information to each listener component. FIGS. 14-21 illustrate processing of functions of the queue class in one embodiment. FIG. 14 is a flow diagram illustrating processing of the constructor of the queue class in one embodiment. The constructor is passed an indication of the queue size. In block 1401, the constructor instantiates an inner queue object passing the queue size and then returns.

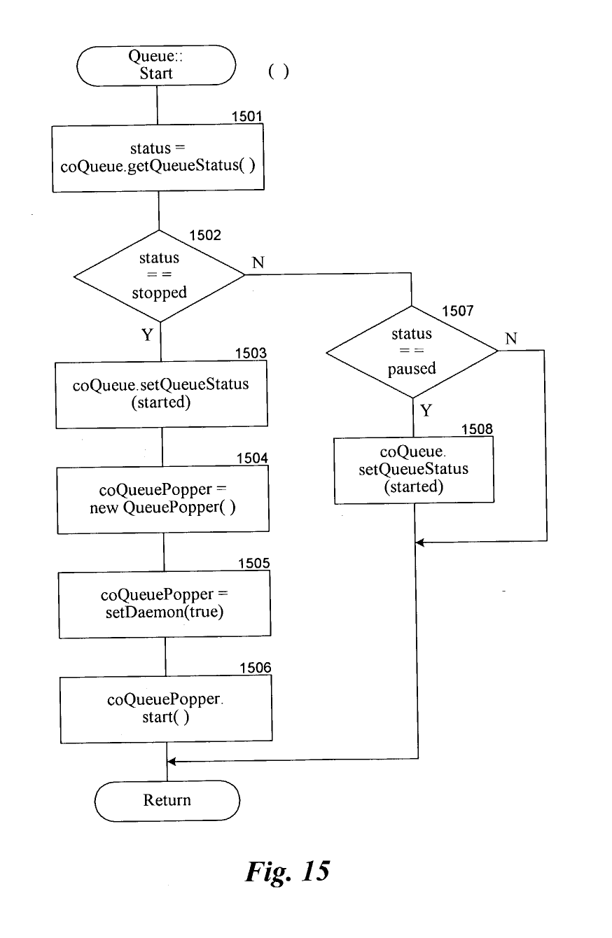

FIG. 15 is a flow diagram illustrating processing of the start function of the queue class in one embodiment. The start function starts the thread that is to pop information off the queue for this node and pass the information to the child nodes in the case of a distribution node and perform the servicing of the information in the case of a service node. In block 1501, the function retrieves the status of the queue. In decision block 1502, if the current status is stopped, then the function continues at block 1503 to start the queue, else the function continues at block 1507. In block 1503, the function sets the current status of the queue to started. In block 1504, the function instantiates a queue popper object. The queue popper object is an implementation of the thread that pops information off the queue and invokes the act component of this node via the listener component. In block 1505, the function sets the daemon of the queue popper object to true. In block 1506, the function starts the queue popper object to start the thread and then returns. In decision block 1507, if the current status of the queue is paused, then the function continues at block 1508, else the function returns. In block 1508, the function sets the current status of the queue to started because the popper object was already instantiated when the queue was started before being paused and then returns.

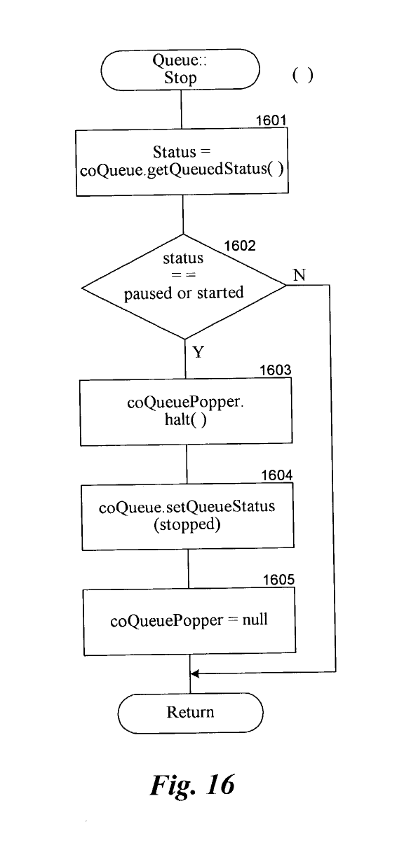

FIG. 16 is a flow diagram illustrating processing of the stop function of the queue class in one embodiment. In block 1601, the function retrieves the current status of the queue. In decision block 1602, if the status of the queue is paused or started, then the function continues at block 1603, else the function returns. In block 1603, the function halts the queue popper object so the thread terminates. In block 1604, the function sets the current status of the queue to stopped. In block 1605, the function sets a reference to the queue popper object to null and then returns.

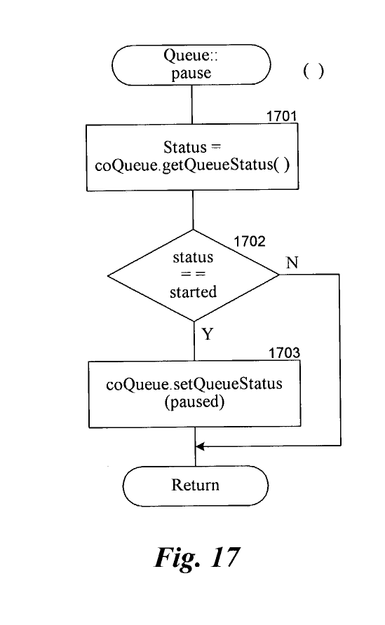

FIG. 17 is a flow diagram illustrating processing of the pause function of the queue class in one embodiment. In block 1701, the function retrieves the current status of the queue. In decision block 1702, if the current status is started, then the function continues at block 1703, else the function returns. In block 1703, the function sets the current status of the queue to paused and then returns.

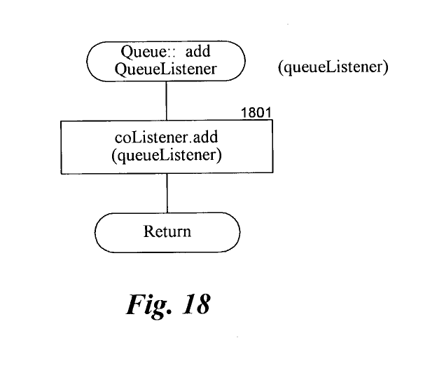

FIG. 18 is a flow diagram illustrating processing of the add queue listener function of the queue class in one embodiment. This function is passed an indication of the object that is the queue listener. In block 1801, the function adds the queue listener to the list of queue listeners and then returns.

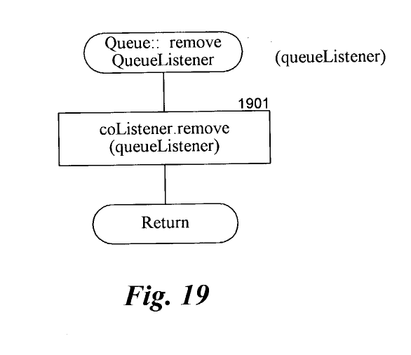

FIG. 19 is a flow diagram illustrating processing of the remove queue listener function of the queue class in one embodiment. This function is passed an indication of the object that is the queue listener and then removes it from the list of queue listeners. In block 1901, the function removes the passed queue listener from the list of queue listeners and then returns.

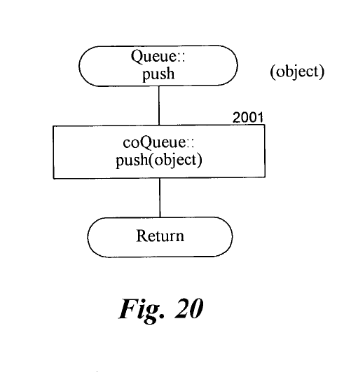

FIG. 20 is a flow diagram illustrating processing of the push function of the queue class in one embodiment. The function is passed the information that is to be pushed onto the queue. In block 2001, the function invokes the push function of the inner queue object and then returns.

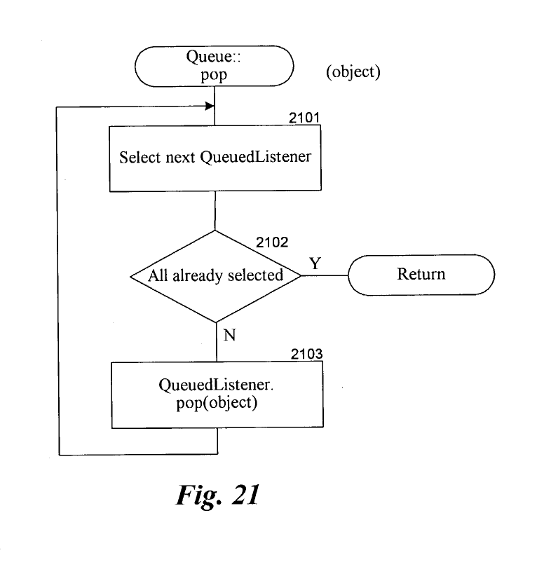

FIG. 21 is a flow diagram illustrating processing of the pop function of the queue class in one embodiment. The pop function loops selecting each queue listener and invoking the pop function of that queue listener. This function is called by the thread when it pops information off the queue. In block 2101, the function selects the next queue listener. In decision block 2102, if all the queue listeners have already been selected, then the function returns, else the function continues at block 2103. In block 2103, the function invokes the pop function of the queue listener and then loops to block 2101 to select the next queue listener.

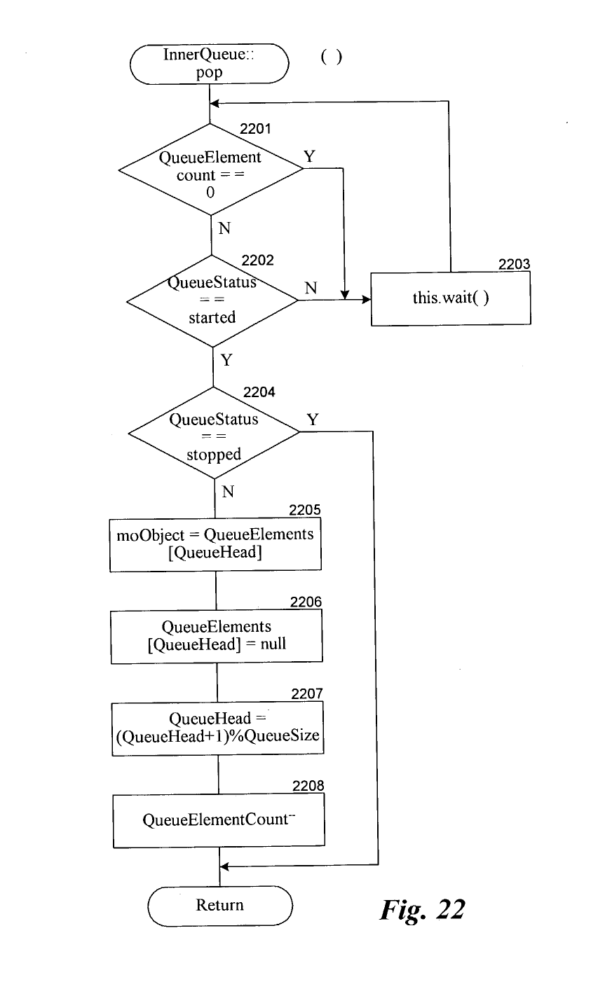

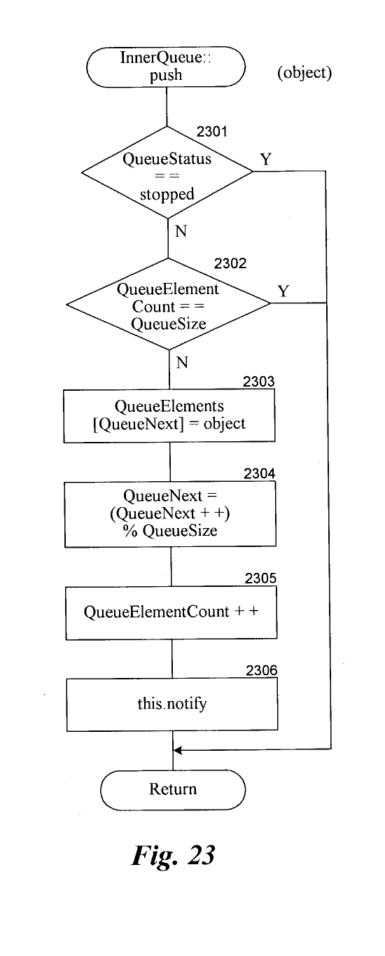

FIGS. 22 and 23 are flow diagrams illustrating processing of the functions of the inner queue class in one embodiment. FIG. 22 is a flow diagram illustrating processing of the pop function of the inner queue class in one embodiment. This function pops information off the queue, and if the queue is empty, it waits until information is pushed onto the queue. In decision block 2201, if the queue is empty, then the function continues at block 2203, else the function continues at block 2202. In decision block 2202, if the status of the inner queue is started, then the function continues at block 2204, else the function continues at block 2203. In block 2203, the function waits until it is signaled and then loops to block 2201. The function (or thread) is signaled when information is added to the queue and when the queue is started. In decision block 2204, if the status of the queue is stopped, then the function returns, else the function continues at block 2205. In block 2205, the function retrieves the element from the top of the queue. In block 2206, the function sets the element in the queue to null. In block 2207, the function increments a pointer to point to the head element in the queue wrapping to the beginning of the queue as appropriate. In block 2208, the function decrements the number of elements in the queue and then returns.

FIG. 23 is a flow diagram illustrating processing of the push function of the inner queue class in one embodiment. In decision block 2301, if the status of the inner queue is stopped, then the function returns, else the function continues at block 2302. In block 2302, if the-count of the elements in the queue is equal to the current size of the queue, then the queue is full and the function returns, else the function continues at block 2303. In block 2303, the function adds the information as the next element in the queue. In block 2304, the function increments the pointer to the next available element in the queue wrapping to the beginning of the queue as appropriate. In block 2305, the function increments the count of the elements in the queue. In block 2306, the function performs a notification to notify the thread that an element has been added to the queue and then returns.

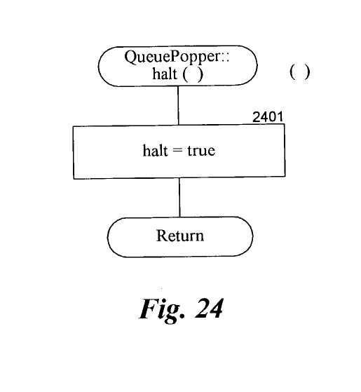

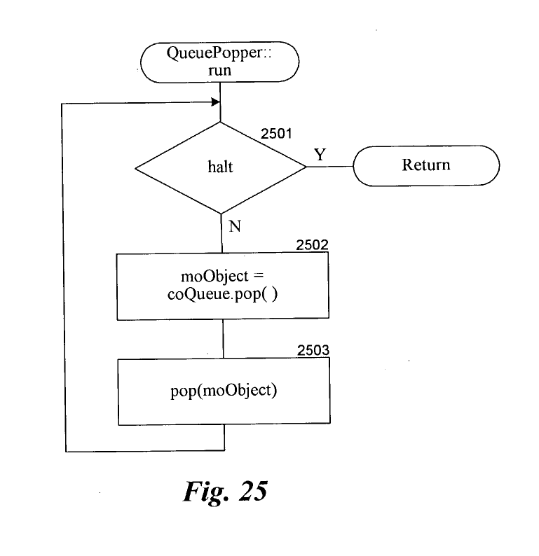

FIGS. 24 and 25 are flow diagrams illustrating processing of functions of the queue popper class in one embodiment. FIG. 24 is a flow diagram illustrating processing of the halt function of the queue popper class in one embodiment. In block 2401, the function sets the halt flag to true and then returns. This causes the thread to terminate.

FIG. 25 is a flow diagram illustrating processing of the run function of the queue popper class in one embodiment. In decision block 2501, if the halt flag is set to true, then the function returns to terminate the thread, else the function continues at block 2502. In block 2502, the function invokes the pop function of the queue to retrieve information from the queue. In block 2503, the function invokes the pop function of the queue passing the retrieve information and then loops to block 2501. The pop function of the queue invokes the act function indirectly through a listener component passing the information.

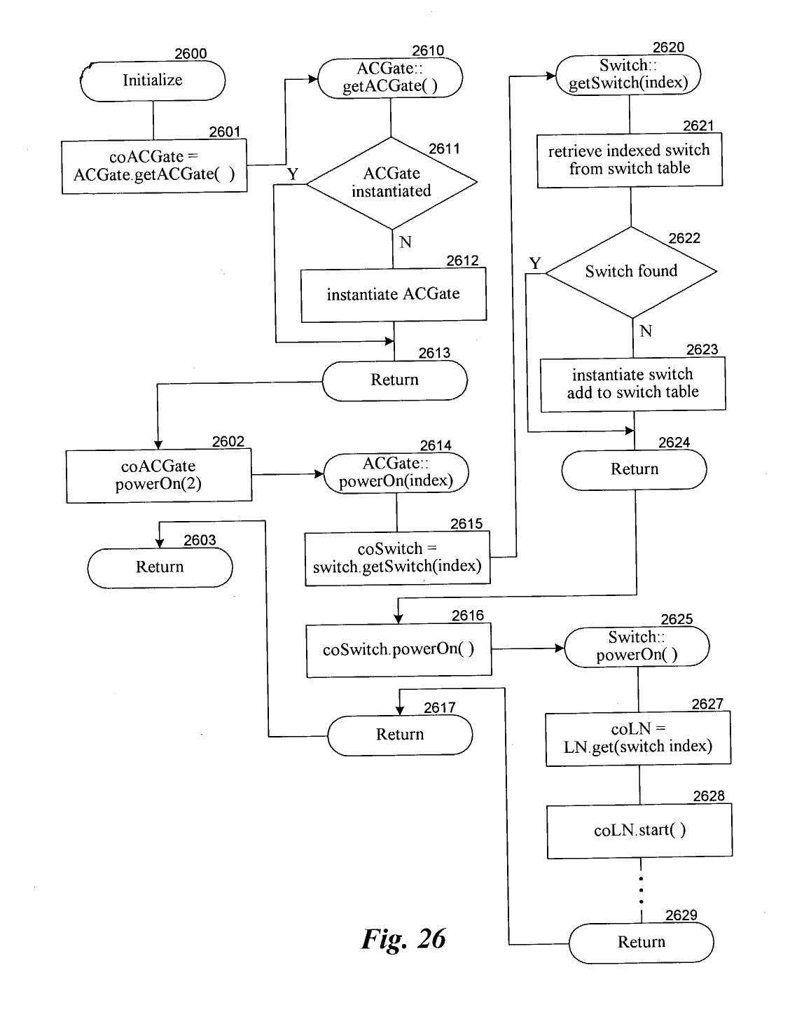

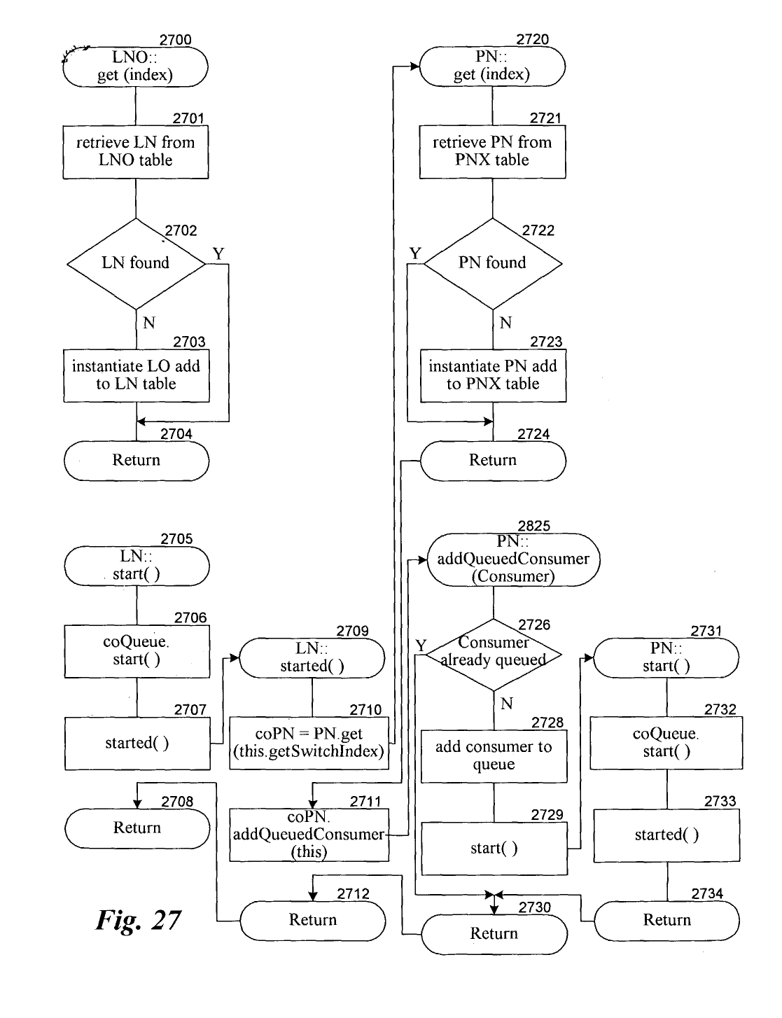

FIGS. 26 and 27 are flow diagrams illustrating the creation of a node hierarchy in one embodiment. FIG. 26 illustrates the processing of an initialize function, functions of the distribution gate, and functions of a switch. Blocks 2600-2603 illustrate processing of the initialize function. Blocks 2610-2617 illustrate processing of the distribution gate. Blocks 2620-2629 illustrate processing of the switch component. In block 2601, the initialize component invokes the get gate function of the distribution gate component. In block 2611, if the gate object is instantiated, then the function continues at block 2613, else the function continues at block 2612. The gate object is a singleton. In block 2612, the function instantiates the gate and then returns in block 2613. On return, in block 2602, the initialize component invokes the power on function of the gate object passing an indication of the index of the node hierarchy to be created. In block 2615, the power on function invokes the get switch function of the switch class. In block 2621, the get switch function,retrieves the indexed switch from the switch table. In decision block 2622, the switch is found, then the function continues at block 2624, else the function continues at block 2623. In block 2623, the function instantiates a switch object and adds it to the switch table. In block 2624, the get switch function returns. In block 2616, the power on function of the gate invokes the power on function of the switch. In blocks 2627-2628, the power on function of the switch invokes the get function for each type of leaf node that is to be instantiated and invokes the start function of the instantiated leaf nodes. The “LN” in blocks 2627 and 2628 represents the class name of the leaf node. In block 2629, the power on function of the switch returns to the power on function of the gate. In block 2617, the power on function of the gate returns to the initialize component. In block 2603, the initialize component completes.

FIG. 27 is a flow diagram illustrating the instantiation of a leaf node and its parent node in one embodiment. Blocks 2700-2712 illustrate the processing of a leaf node. The get and start functions of the leaf nodes are invoked by the switch component. The get function is a static function for the nodes of that type, which means that the function can be invoked independently of any of the nodes of that type. In block 2701, the get function of the leaf node retrieves an entry for that index from the leaf node table. Each node type has its own node table. In decision block 2702, if an entry is found, then the function returns, else the function instantiates a node of the leaf node type and adds to the table a mapping of the index to the instantiated leaf node in block 2703. In block 2704, the function returns to the invoking switch object. In block 2706, the start function of the leaf node object starts the queue. In block 2707, the start function of the leaf node object then invokes the started function of the leaf node object. In block 2710, the started function of the leaf node object invokes the get function of parent object passing the index of the leaf node. The “PN” in blocks 2710 and 2711 represents the class name of the parent node. In block 2721, the get function of the parent node object retrieves an entry for the passed index from its node table. In decision block 2722, if an entry is found, then the function returns in block 2724, else the function continues at block 2723. In block 2723, the function instantiates a node of the parent node type and adds a mapping of the index to the instantiated node into the parent node table and then returns in block 2724. In block 2711, the started function of the leaf node object invokes the add queued consumer function of the parent node passing a reference to the leaf node object. In decision block 2726, if the passed leaf node object (i.e., consumer) is already in the consumer store, then the function continues at block 2730, else the add queued consumer function continues at block 2728. In block 2728, the add queued consumer function adds the consumer to the consumer store. In block 2729, the add queued consumer function invokes the start function of the parent node. In block 2732, the start function of the parent node invokes the start function of the queue. In block 2733, the start function of the parent node invokes the started function of the parent object and then returns in block 2734 to the add queued consumer function. The started function of the parent node object instantiates and registers with its parent node the same way as done by the leaf node object in blocks 2710 and 2711. In block 2730, the add queued consumer function returns to the started function of the leaf node. In block 2712, the started function of the leaf node returns to the start function of the leaf node. In block 2708, the start function of the leaf node returns to the switch at block 2628 to complete the processing.

From the foregoing, it will be appreciated that although specific embodiments of the invention have been described herein for purposes of illustration, various modifications may be made without deviating from the spirit and scope of the invention. For example, the size and types of the various data structures can be adjusted dynamically to meet current needs, rather than being set to a fixed size at instantiation. Also, the functions of the nodes and inter-node communications can be adjusted to meet the varying design goals. For example, a distribution node may invoke an accept function of each child node and then pass the information to the child node only when it is determined to be acceptable. Such processing may be desirable when, for example, the distribution node and child node are on different computer systems and the child node can provide the distribution node with a copy of its accept function for local invocation. Accordingly, the invention is not limited except as by the appended claims.

I/we claim:

1. A distribution node of a computer system for distributing information, comprising:
a queue that stores information;
a pass component that is provided information, determines whether the provided information is to be processed by the distribution node, and when the provided information is to be processed by the distribution node, stores the provided information in the queue;
an act component that is provided information and passes the provided information to a pass component of each child node of the distribution node; and
a thread component that retrieves information from the queue and invokes the act component providing the retrieved information.

2. The distribution node of claim 1 wherein each child node registers with the distribution node.

3. The distribution node of claim 2 wherein the registering includes providing information so that the distribution node can invoke the pass component of the child node.

4. The distribution node of claim 1 wherein the distribution node is implemented as an object with the pass component and act component being functions of the object.

5. The distribution node of claim 1 wherein the distribution node is part of a node hierarchy of distribution nodes.

6. The distribution node of claim 1 including an accept component that determines whether the provided information is to be processed by the distribution node.

7. The distribution node of claim 6 wherein the pass component invokes the accept component to determine whether the provided information is to be processed by the distribution node.

8. The distribution node of claim 6 wherein the pass component and accept components are common to multiple distribution nodes and the accept component may be customized for each distribution node.

9. The distribution node of claim 1 wherein a child node is a service node.

10. The distribution node of claim 1 wherein a child node is a distribution node.

11. A method in a computer system for distributing information to services, the method comprising:
providing a node hierarchy including distribution nodes and service nodes;
under control of each distribution node,
when information to be distributed is received at the distribution node,
determining whether information is to be accepted by the distribution node;
when the information is to be accepted by the distribution node, storing the information for further processing by the distribution node;
processing the stored information by retrieving the stored information and providing the stored information to child nodes of the distribution node, wherein the processing occurs in a separate thread from the determining and storing; and
under control of each service node,
when information to be distributed is received at the service node, performing the service based on the received information.

12. The method of claim 11 wherein the service nodes are leaf nodes within the node hierarchy.

13. The method of claim 11 wherein the service nodes determine whether the received information is to be accepted before performing the service.

14. The method of claim 11 wherein the nodes of the node hierarchy are distributed over multiple computers.

15. The method of claim 11 wherein a distribution node is implemented by inheriting a consumer class with a pass component that receives information, that invokes the accept component to determine whether the information is to be processed by the distribution node, and that when the information is to be processed, stores the information.

16. The method of claim 15 wherein the consumer queue class includes an abstract accept component and an abstract act component.

17. The method of claim 16 wherein the processing by the separate thread retrieves information and that invokes the pass component of each child node.

18. The method of claim 15 wherein each service node includes a pass component that is invoked by a parent node to pass information to the service node.

19. The method of claim 18 wherein each service node is implemented by inheriting the consumer class.

20. A method in a computer system for creating a node hierarchy, each node in the hierarchy having a node type, the method comprising:
for each of a plurality of node types,
creating a node of that node type when a node of that type is not already instantiated, the created node having a parent node type;
under control of the created node, creating a parent node of the parent node type for the created node when a parent node of that parent type is not already instantiated, the parent node optionally having a parent node type
wherein each parent node is passed information and selectively passes the information to its child nodes down through the node hierarchy.

21. The method of claim 20 wherein each parent node has an accept component for determining whether passed information should be passed to its child nodes.

22. The method of claim 20 including destructing a node when all its child nodes have been destructed.

23. The method of claim 20 wherein each parent node is a consumer queue object.

24. The method of claim 20 wherein multiple node hierarchies are created each with a different index.

25. The method of claim 20 wherein multiple node hierarchies are created and including receiving information and passing it to a root node of a hierarchy.

26. The method of claim 20 wherein each node is implemented by inheriting a consumer class with a pass component that receives information, that invokes the accept component to determine whether the information is to be processed by the node, and that when the information is to be processed, stores the information.

27. The method of claim 20 wherein when a node is removed from the node hierarchy, removing its parent node when the parent node has no child nodes.

28. The method of claim 20 wherein leaf nodes can be dynamically added to the node hierarchy.

29. The method of claim 20 wherein leaf nodes can be dynamically removed from the node hierarchy.

30. A distribution node of a computer system for distributing information, comprising:
pass means for receiving information, determining whether the received information is to be processed by the distribution node, and when the received information is to be processed by the distribution node, storing the received information;
act means for receiving information and passing the provided information to the pass means of each child node of the distribution node; and
thread means for retrieving the stored information and invoking the act means sending the retrieved information.

31. The distribution node of claim 30 wherein each child node registers with the distribution node.

32. The distribution node of claim 30 wherein the distribution node is implemented as an object with the pass means and act means being functions of the object.

33. The distribution node of claim 30 wherein the distribution node is part of a node hierarchy of distribution nodes.

34. The distribution node of claim 30 including accept means for determining whether the provided information is to be processed by the distribution node.

35. The distribution node of claim 30 wherein a child node is a service node.

36. The distribution node of claim 30 wherein a child node is a distribution node.

37. A computer-readable medium containing instructions for controlling a computer system to distribute information to services via a node hierarchy of distribution nodes and service nodes, by a method comprising:
under control of each distribution node,
when information to be distributed is received at the distribution node,
determining whether, information is to be accepted by the distribution node;
when the information is to be accepted by the distribution node, storing the information for further processing by the distribution node;
processing the stored information by retrieving the stored information and providing the stored information to child nodes of the distribution node, wherein the processing occurs in a separate thread from the determining and storing; and
under control of each service node,
when information to be distributed is received at the service node, performing the service based on the received information.

38. The computer-readable medium of claim 37 wherein the service nodes are leaf nodes within the node hierarchy.

39. The computer-readable medium of claim 37 wherein the service nodes determine whether the received information is to be accepted before performing the service.

40. The method of claim 37 wherein a distribution node is implemented by inheriting a consumer class with a pass component that receives information, that invokes the accept component to determine whether the information is to be processed by the distribution node, and that, when the information is to be processed, stores the information.

41. A method in a computer system for maintaining a node hierarchy, each node in the hierarchy having a node type, the method comprising:
providing a plurality of node types wherein a node of each node type when created connects to a parent node of a parent node type unless the node is a root node and when a last child node disconnects, disconnects from its parent node and destroys itself;
dynamically creating leaf nodes of the node hierarchy, wherein each leaf node connects to its parent node which transitively connects to their parent nodes; and
dynamically removing leaf nodes of the node hierarchy, wherein each leaf node disconnects from its parent node and destroys itself and its parent node transitively removes itself when it has no child nodes.

42. The method of claim 41 wherein the node hierarchy is for distributing information to leaf nodes.

43. The method of claim 42 wherein the leaf nodes are service nodes and the non-leaf nodes are distribution nodes.

44. The method of claim 40 wherein multiple node hierarchies are created each with a different index.

45. The method of claim 40 wherein multiple node hierarchies are created and including receiving information and passing it to a root node of a node hierarchy.
